(19) United States
(12) Patent Application Publication
(10) Pub. No.: US 2008/0171206 A1
(43) Pub. Date: Jul. 17, 2008

(54) Method Of Producing A Component With A Surface Structure, Ceramic Component And Application Of Such A Method

(75) Inventors: Marcus Antonius Verschuuren, Eindhoven (NL); Jan De Graaf, Eindhoven (NL); Theo Arnold Kop, Eindhoven (NL)

Correspondence Address: PHILIPS ELECTRONICS NORTH AMERICA CORPORATION;INTELLECTUAL PROPERTY & STANDARDS, 370 W. TRIMBLE ROAD MS 91/MG, SAN JOSE, CA, 95131, US

(73) Assignee: KONINKLIJKE PHILIPS ELECTRONICS N.V., Eindhoven (NL)

(21) Appl. No.: 11/908,326

(22) PCT Filed: Mar. 10, 2006
(86) PCT No.: PCT/IB06/50751

§ 371 Date: Sep. 11, 2007

(30) Foreign Application Priority Data
Mar. 14, 2005 (EP) 05101939.6
Sep. 11, 2007 (IB) PCT/IB2006/050751

(51) Int. Cl. B32B 3/00; B28B 1/26; B29D 11/00

(52) U.S. Cl. 428/409; 264/86; 264/1.21

(57) ABSTRACT

A method of producing a component with a surface structure (4) includes providing a suspension of particles susceptible to sintering in a liquid medium, providing a stamp element (2) having a structured surface (7) provided with a negative imprint of at least a part of the surface structure (4), providing a mould (1) including a receptacle (5), introducing a quantity of the suspension (6) in the receptacle (5), and applying the structured surface (7) of the stamp element (2) to the suspension in the receptacle. The receptacle of the mould has least one porous wall (8,9). The structured surface (7) of the stamp element (2) is applied whilst at least part of the liquid medium is drained through the porous wall(s) (8,9)

The invention relates to a method of producing a component with a surface structure, including

providing a suspension of particles susceptible to sintering in a liquid medium,

providing a stamp element having a structured surface provided with a negative imprint of at least a part of the surface structure,

providing a mould including a receptacle,

introducing a quantity of the suspension in the receptacle, and

applying the structured surface of the stamp element to the suspension in the receptacle.

The invention also relates to an application of such a method.

The invention also relates to a ceramic component obtainable by means of such a method.

An example of a method as defined above is known. Gebhardt, S. et al., “Fine Scale 1-3 Composites Fabricated by the Soft Mold Process: Preparation and Modeling’, Ferroelectrics, Vol. 241, (2000), pp. 67-73, contains an evaluation of a soft mold process allowing the fabrication of 1-3 composites with rods of different size, shape and spacing. As described therein, the idea of the soft mold process is to use master molds which have been structured by microsystem technologies. In the evaluated method, silicon master molds were applied. They had been structured by a deep reactive ion etching process which provides high aspect ratio structures. From Si master molds numerous templates of a soft plastic were taken and filled with a ceramic slip. After drying, the ceramic green body could be demolded without defects. After binder burnout and sintering in PbO controlled atmosphere, the structures were filled with an epoxy resin and the base was removed by grinding. The resulting 1-3 composites were subsequently electroded and poled.

A disadvantage of the known method is that the binder burnout gives rise to an irregular surface due to larger grain sizes in the ceramic structure. To obtain a sufficiently smooth surface for many applications, mechanical finishing is required. This in turn is an impediment to forming structures with high aspect ratios.

It is an object of the invention to provide a method and ceramic component of the kind mentioned above, that enable production of components with a higher surface quality.

This object is achieved by means of the method according to the invention which is characterized in that the receptacle of the mould has at least one porous wall, and in that the structured surface of the stamp element is applied whilst at least part of the liquid medium is drained through the porous wall(s).

Because the liquid medium is at least partly drained whilst the structured surface of the stamp element is applied, a high packing density results. As a consequence, less binder, preferably none at all, is needed to maintain the shape stability of the green body. Because the liquid medium is drained through the porous wall(s), it is drained in a homogeneous manner, and to other sides than that of the surface structure. This leads to a homogeneous green body that can be sintered to a dense compact at a relatively low sintering temperature. This in turn leads to smaller grain sizes, particular at the location of the surface structure. A smoother surface is the result.

In a preferred embodiment, at least a portion of the stamp element providing the structured surface is made of an, at least temporarily, deformable material.

Thus, the risk of deformation of the green body when the stamp is removed is reduced.

Preferably, the deformable material is elastic.

Thus, the stamp can be used again, as the fact that it is elastic means that it returns to its original shape after deformation.

In a preferred embodiment, a bottom wall of the receptacle includes a porous wall having a substantially isotropic pore density.

This has the effect that the liquid medium is drained evenly. As a result, there is a homogeneous distribution of particles in the resulting green body.

In a preferred embodiment, the receptacle is provided with a substantially planar bottom surface.

Thus, there is practically no gradient in material properties in the plane of the surface structure, as there is practically no gradient during the draining off of at least part of the liquid medium through the porous wall or walls.

A preferred embodiment includes providing a suspension at least substantially free of binder substances, preferably completely free.

Thus, there is no need to burn out the binder upon formation of the green body. Therefore fewer interstices will be present in the green body, and also in the finished component after sintering. Due to the absence of binders in the green body, the thermal treatment necessary to obtain dense powder compacts for sintering will be less severe. This in turn means that little or no mechanical finishing is necessary to obtain a good surface quality.

Preferably, the method includes applying the structured surface of the stamp element in such a manner that a pressure substantially at or below the sum of the pressure due to gravitational pull on the stamp element and atmospheric pressure is exerted on the quantity of suspension.

This has the effect of reducing the stresses in the powder compact that is formed when draining off the liquid medium. Low stresses help to avoid differences in packing density in the powder compact.

A preferred embodiment includes draining off substantially all liquid medium from the quantity of the suspension to leave a powder compact as a residue and subsequently sintering the powder compact.

Because substantially all liquid medium is drained off, the sintering process is mainly needed only to fuse the particles. The result is that the sintering process can be kept relatively brief. Moreover, the required sintering temperature is lower. This in itself helps achieve a lower surface roughness.

According to another aspect of the invention, the method according to the invention is applied in the manufacture of a ceramic optical component having a reflective and/or refractive surface structure.

Ceramic optical components are very desirable, because of the inherent properties of ceramic components in general. These advantageous properties include low thermal expansion coefficients, high thermal stability, high refraction indices, dielectric properties, high thermal conductivities and stability under high Ultra Violet (UV) fluxes. By applying the methods according to the invention, optical components with a high aspect ratio and low surface roughness relative to optical wavelengths (˜380-800 nm) are attainable at relatively low expense. In particular, complicated machining (grinding, polishing) is avoided to a large extent.

According to another aspect of the invention, there is provided a ceramic component obtainable by means of a method according to the invention.

The component is characterized by being relatively free of marks due to mechanical machining and a low surface roughness having a value in a range hitherto unattainable without such mechanical finishing. In particular, the surface roughness is lower than 800 nm, more preferably lower than 400 nm. Light impinging on the surface is thus not scattered appreciably. Preferred embodiments of the component are characterized by having a structured surface with shapes more complicated than are attainable by machining.

The invention will now be explained in further detail with reference to the accompanying drawings, in which:

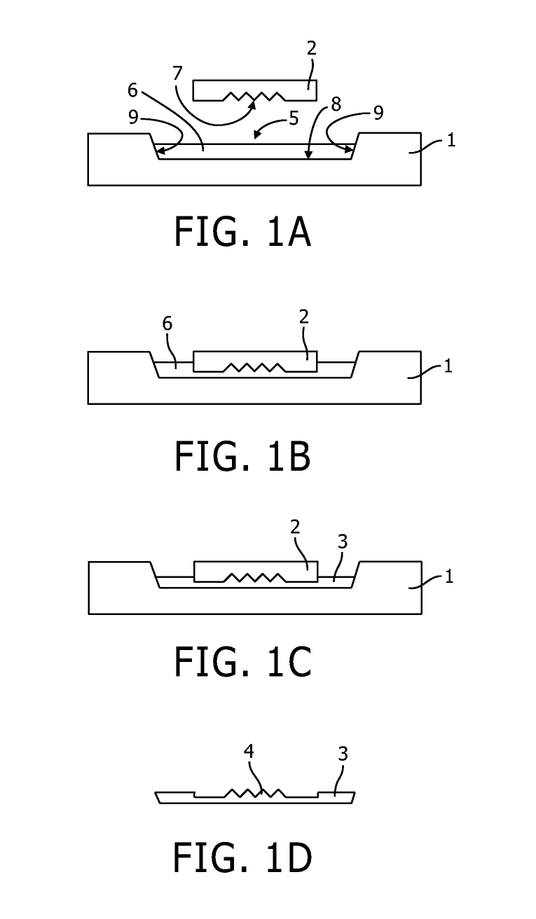

FIGS. 1A-1D show in a very schematic fashion several steps in a method of producing a ceramic component; and

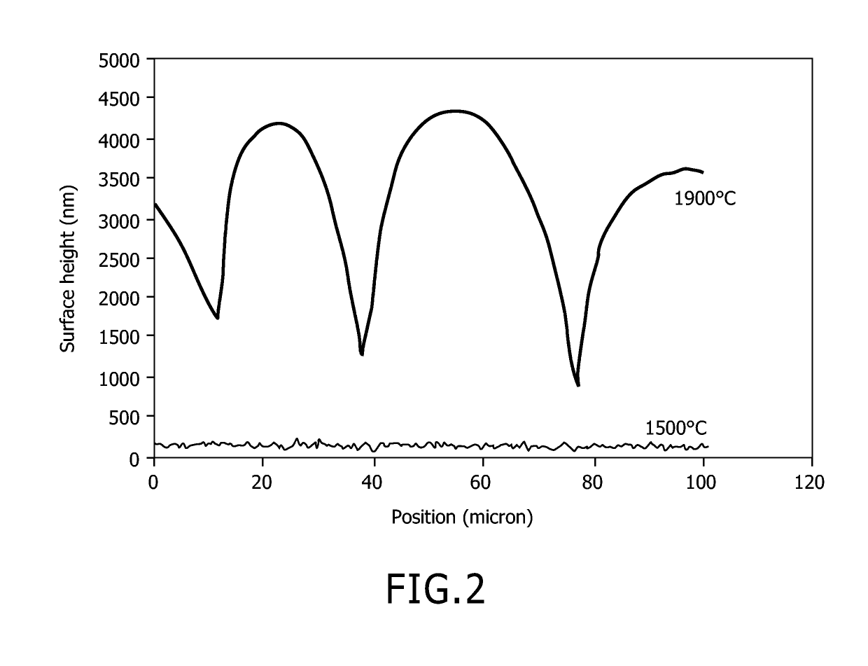

FIG. 2 is a diagram comparing the surface roughness of a ceramic component sintered at 1900° C. to that of a ceramic component sintered at 1500° C.

In FIG. 1, a mould 1 and stamp element 2 are shown for producing a powder compact 3 with a surface structure 4 on an upper surface. The mould 1 includes a receptacle 5. A quantity of a suspension 6 of particles susceptible to sintering, preferably of a ceramic material, is poured into the mould 1 to result in the stage illustrated in FIG. 1A.

Exemplary compositions include, but are not limited to oxides, carbides, nitrides, silicides, borides, silicates, titanates, zirconates and mixtures thereof, as well as aluminium, barium, beryllium, boron, calcium, magnesium,_lanthanum and other lanthanides, lead, silicon, tungsten, titanium, zirconium and mixtures thereof. In any case, the component comprises particles of a material, preferably an oxide, susceptible to sintering, i.e. having the property of coalescing under the influence of heat without actually liquefying. In favorable embodiments, a ceramic material transparent to light in the visible wavelengths is used, in order to produce an optical component. Examples of suitable ceramics for this purpose include Al₂O₃ and YAG. Other examples of candidate materials include AlON, MgAl₂O₄, Y₂O₃, Si₂Al₆O₁₃, AlN, SiC, SiN, MgO, SiO₂, Li₂O and ZrO₂.

The liquid medium in which the particles are suspended may include a mixture. In a preferred, and simple embodiment, the main component of the liquid medium is water. Additives may be used, for example a dispersant, to impart desirable properties to the suspension. It is, however, preferred to use a suspension that is substantially free of any binding substances. Binders are substances that act cohesively to keep the particles together prior to sintering. Since the suspension is free of binders, these do not have to be burnt out after shaping the component. Burning out binders leaves interstices in the resulting powder compact. High sintering temperatures are required to remove these interstices. These factors contribute to an undesired increase in surface roughness.

In a preferred embodiment, the particles have a particle size distribution predominantly within the range of 0.01-25 μm, more preferably 0.01-2 μm. This contributes to a high packing density upon drying. A suitable powder is obtainable from Konoshima Chemical Company Ltd.

The stamp element 2 has a structured surface 7 presenting a negative imprint of at least a part of the surface structure 4. It is thus a negative of a part of the surface structure 4 that protrudes from the upper surface of the powder compact 3 when it has been formed.

FIG. 1B shows a stage in which the structured surface 7 has been applied to the quantity of suspension 6 in the receptacle. In this context, application of the structured surface 7 means immersing at least part of the structured surface 7 in the quantity of suspension 6. Thus, the stamp element is brought into contact with the suspension from one side, namely from the side of the exposed surface. The stamp element 2 will be described more fully below. For now, it is noted that the preferred embodiment of the stamp element 2 is simply left to float on the quantity of suspension 6. Its movement in directions perpendicular to the direction in which it is applied is constrained. It need not necessarily be constrained in its movement in the vertical direction, i.e. the direction of application. Preferably, no pressure other than that due to gravitational pull on the stamp element 2 is exerted on the quantity of suspension 6. In other embodiments, the position of the stamp element 2 is controlled, for example by means of a servo. Then, even less pressure is exerted on the suspension of particles as it is dried to form the powder compact 3.

The receptacle 5 is bounded by at least one porous wall, which preferably includes a bottom wall 8 and, optionally, side walls 9. At least part of the liquid medium comprised in the quantity of suspension 6 is drained off through the porous wall or walls whilst the structured surface 7 of the stamp element 2 is applied. Preferably the pore size is such that the liquid medium is drawn from the receptacle 5 by capillary forces. The pore diameter is lower than the average particle size. In a preferred embodiment, the pore diameter lies in a range of 0.05-5 μm.

In the illustrated embodiment, the (porous) bottom wall 8 is substantially planar. That is to say that the variations in height are at least an order of magnitude lower than those of the surface structure 4 being formed. The surface of the powder compact 3 on a side opposite the side provided with the surface structure 4 is smooth and plane. Preferably the pore density over each porous wall of the receptacle is also isotropic, to provide a powder compact 3 with a homogeneous grain size.

In alternative embodiments (not shown), the (porous) bottom wall of the receptacle 5 is provided with a shaped or structured surface. This has the advantage of increasing the range of attainable green body shapes with little additional manufacturing effort. A shaped wall may impart a certain curvature to a surface of the green body, for example. A structured bottom wall of the receptacle 5 would be provided with a negative imprint of a surface structure to be provided on an opposite side to the surface structure 4 provided by the stamp element 2.

Substantially all the liquid medium is drained off in the transition from the stage shown in FIG. 1B to the one depicted in FIG. 1C, thus leaving the powder compact behind in the receptacle 5. Then, contact between the structured surface 7 of the stamp element 2 and the surface structure 4 of the powder compact 3 is broken. The powder compact 3 is removed from the mould 1, to attain the stage shown in FIG. 1D. After that, the powder compact 3 is sintered.

In a preferred embodiment, the mould 1 is made of the same material as the particles susceptible to sintering, or at least has the same major components. This promotes the release of the powder compact 3, by lessening adhesion to the mould 1. Optionally, an additional coating is provided on the bottom wall 8 and side walls 9 to facilitate the release of the powder compact 3 from the mould 1.

The stamp element 2, or at least the portion providing the structured surface 7, is made of a deformable material, to further prevent deformation of the green body when contact with the stamp element 2 is broken. In some embodiments, the stamp element 2 is substantially rigid, and deformed through a heat treatment, like melting or burning, or dissolution. In the preferred embodiment, the stamp element 2 is re-usable, to which end it is made of an elastomeric material, such as PDMS (silicone rubber). Other materials commonly applied in soft molding processes may also be used. The structured surface 7 may be coated to make it hydrophilic or hydrophobic and/or to lessen adhesion to the particles in the powder compact 3. A stamp element 2 with a relatively low modulus of elasticity is used to form a surface structure including features with a relatively high aspect ratio. A value is chosen such that the surface of the stamp element 2 deforms to an extent within the same order of magnitude as the grain size in the powder compact 3 when subjected to a tension of the same order of magnitude as the breaking stress of the powder compact 3.

Following the stage shown in FIG. 1D, the powder compact 3 is sintered. Due to the well packed, homogeneous distribution of small particles attainable by means of the method illustrated in FIGS. 1A-1D, small grain sizes are attainable. In particular, the powder compact 3 is much better packed than would be the case if it had been formed using a different technique, such as injection molding or extrusion. This allows sintering at a relatively low temperature. For an Al₂O₃-powder compact 3, the sintering temperature is preferably a value within the range of 1000° C.-1500° C., more preferably within the range of 1100° C.-1500° C. FIG. 2 shows the beneficial effects associated with using such a relatively low temperature.

FIG. 2 shows the surface morphology of sintered ceramic components made with the method presented herein, using aluminium oxide as ceramic material. One graph is associated with a component sintered at 1500° C., the other with a component sintered at 1900° C. The one sintered at the lower temperature has an optically smooth surface geometry, in contrast to the other. It is noted that there are no polishing marks such as scratches, etched grain boundaries, etc. This, together with the high aspect ratios of the features included in the surface structure, characterizes the ceramic components obtainable by means of the above-described methods.

An example of a component with a surface structure made by means of the method outlined above included features comprising cups in a planar surface. The cups had a depth, measured from the surface, of 0.13 mm. They were made in the shape of a parallelepiped having a 1 mm square base. The base was located in the plane of the surface. Due to the small grain size that can be attained using the above-described methods, the edges of the cups, and also the corner points, could be kept within a tight tolerance range.

In general, the methods outlined herein are suitable for obtaining surface structures including features having an aspect ratio of at least 3.5, with a maximum of about 10. Here, the aspect ratio is defined as the length of a feature divided by its width. The length of an indentation corresponds to its depth from the surface in which it is provided, whereas the length of a free-standing feature (for instance a column) equals the distance over which it projects from a surface. The width corresponds to its smallest lateral dimension in the plane of the surface. The features can have dimensions in the millimeter or micrometer range. The lower limit is about six times the grain size typically obtainable by sintering the component, generally just below one micron. The upper limit lies in a range around 10 cm.

Examples of components that can be made using the above-described methods include all kinds of structures in a variety of different ceramics for a multitude of applications. Examples of components include heat pipes, ultrasound transducers, tool bits and bone growth sensors, all of them with micrometer-sized features.

When the component is made of an optically transparent or reflective material, optical components can be made. A coating may be applied to impart reflective properties to the surface structure 4. Examples of optical components include high refractive index collimator lenses for Light Emitting Diodes (both Fresnel lenses and ‘normal’ lenses), substrates for LEDs with high thermal conductivity, spherical or a-spherical lenses for recording devices, etc.

All these applications make advantageous use of the advantageous properties due to the use of (preferably) a soft stamp element 2, a well-stabilized suspension, the mould 1 with the appropriate capillary forces and a moderate sintering temperature.

It should be noted that the above-mentioned embodiments illustrate, rather than limit, the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

1. Method of producing a component with a surface structure, including
providing a suspension of particles susceptible to sintering in a liquid medium,
providing a stamp element having a structured surface provided with a negative imprint of at least a part of the surface structure,
providing a mould including a receptacle,
introducing a quantity of the suspension in the receptacle, and
applying the structured surface of the stamp element to the suspension in the receptacle, characterized in that the receptacle of the mould has at least one porous wall, and in that the structured surface of the stamp element is applied whilst at least part of the liquid medium is drained through the porous wall(s).

2. Method according to claim 1, wherein at least a portion of the stamp element (2) providing the structured surface (7) is made of an, at least temporarily, deformable material.

3. Method according to claim 2, wherein the deformable material is elastic.

4. Method according to claim 1, wherein a bottom wall of the receptacle includes a porous wall having a substantially isotropic pore density.

5. Method according to claim 1, wherein the receptacle is provided with a substantially planar bottom surface.

6. Method according to claim 1, including providing a suspension substantially free of binder substances.

7. Method according to any one of the preceding claims, including applying the structured surface of the stamp element in such a manner that a pressure substantially at or below the sum of the pressure due to gravitational pull on the stamp element and atmospheric pressure is exerted on the quantity of suspension.

8. Method according to claim 1, including draining off substantially all liquid medium from the quantity of the suspension to leave a powder compact as a residue and subsequently sintering the powder compact.

9. Application of a method according to claim 1 in the manufacture of a ceramic optical component having a reflective and/or refractive surface structure.

10. Ceramic component obtainable by means of a method according to claim 1.
